(19) United States
(12) Patent Application Publication
(10) Pub. No.: US 2002/0124710 A1
(43) Pub. Date: Sep. 12, 2002

(54) Pipe cutting system

(76) Inventor: Dan A. MacDonald, Athol, ID (US)

Correspondence Address: Michael S. Neustel, 2534 South University Drive, Suite No.4, Fargo, ND, 58103, US

(21) Appl. No.: 09/803,192

(22) Filed: Mar. 8, 2001

(51) Int. Cl. B26D 3/08

(52) U.S. Cl. 83/879; 83/884; 83/456; 83/382

(57) ABSTRACT

A pipe cutting system for quickly and efficiently severing a cast iron pipe. The pipe cutting system includes a table having an upper slot, a hydraulic pump unit, a hydraulic cylinder, and a cutting chain attached between the hydraulic cylinder and the table extending upwardly through the slot in a looped manner. A first guide roller and a second guide roller guide the cutting chain during operation. The cast iron pipe is positioned within looped portion of the cutting chain exposed above the table through the slot and then the hydraulic cylinder is actuated to draw the cutting chain taut about the pipe until the pipe is cut.

### BACKGROUND OF THE INVENTION

1. Field of the Invention

The present invention relates generally to cast iron pipe cutters and more specifically it relates to a pipe cutting system for quickly and efficiently severing a cast iron pipe.

Cast iron pipes are difficult to work with. Conventional tools required to cut the cast iron pipes are difficult to utilize and require extensive amounts of time to severe a cast iron pipe. An example of a cast iron pipe is a soil pipe that is typically comprised of a drainpipe that carries off wastes from a plumbing fixture, especially from a toilet. Various other types of pipes are constructed of cast iron that require quick and efficient cutting in the workplace. Hence, there is a need for a system that will quickly and efficiently severing a cast iron pipe.

2. Description of the Prior Art

Conventional cast iron pipe cutters have been in use for years. Typically, a conventional pipe cutter is comprised of a hand manipulated structure. The RIDGE TOOL COMPANY manufactures a series of pipe cutters under the registered trademark RIDGID such as the No. 246 Soil Pipe Cutter. Conventional pipe cutters, as those made by RIDGE TOOL COMPANY, are typically comprised of a plurality of cutter wheels interconnected into a chain that surround a cast iron pipe and a hand leverage mechanism that applies a tightening force upon the chain thereby causing the cutting wheels to cut (i.e. break) the cast iron pipe. There are various structures for applying a tightening force to the cutting chain as are illustrated in the No. 246, No. 206, and No. 266 Soil Pipe Cutters manufactured by RIDGE TOOL COMPANY.

The main problem with conventional cast iron pipe cutters is that they are laborintensive typically requiring significant amounts of time and labor to cut a cast iron pipe. It is not uncommon for an individual to expend over one minute cutting a cast iron pipe in only one location with conventional cast iron pipe cutters. Another problem with convention cast iron pipe cutters is that they are not easy to operate and sometimes cause physical injuries to the user. A further problem with conventional cast iron pipe cutters is that they require significant physical forces applied by the user. Another problem with conventional cast iron pipe cutters is that they require the user to manually adjust the length of the cutting chain to accommodate the various diameters of cast iron pipe. A further problem with conventional pipe cutter devices is that they require the usage of awkward to utilize elongate handles to apply leverage forces upon the cutting chain.

Examples of patented pipe cutter devices which are illustrative of such prior art include U.S. Pat. No. 4,682,919 to Mitchell; U.S. Pat. No. 4,757,977 to Krieg; U.S. Pat. No. 5,249,344 to McGuire; U.S. Pat. No. 4,490,909 to Wachs et al.; U.S. Pat. No. 4,318,289 to Eaton; U.S. Pat. No. 3,815,455 to Carrell et al.; U.S. Pat. No. 3,942,248 to Sherer et al.; and U.S. Pat. No. 3,614,077 to Blackburn et al.

While these devices may be suitable for the particular purpose to which they address, they are not as suitable for quickly and efficiently severing a cast iron pipe. Conventional cast iron pipe cutters are difficult to utilize and are labor intensive.

In these respects, the pipe cutting system according to the present invention substantially departs from the conventional concepts and designs of the prior art, and in so doing provides an apparatus primarily developed for the purpose of quickly and efficiently severing a cast iron pipe.

### SUMMARY OF THE INVENTION

In view of the foregoing disadvantages inherent in the known types of cast iron pipe cutters now present in the prior art, the present invention provides a new pipe cutting system construction wherein the same can be utilized for quickly and efficiently severing a cast iron pipe.

The general purpose of the present invention, which will be described subsequently in greater detail, is to provide a new pipe cutting system that has many of the advantages of the cast iron pipe cutters mentioned heretofore and many novel features that result in a new pipe cutting system which is not anticipated, rendered obvious, suggested, or even implied by any of the prior art cast iron pipe cutters, either alone or in any combination thereof.

To attain this, the present invention generally comprises a table having an upper slot, a hydraulic pump unit, a hydraulic cylinder, and a cutting chain attached between the hydraulic cylinder and the table extending upwardly through the slot in a looped manner. A first guide roller and a second guide roller guide the cutting chain during operation. The cast iron pipe is positioned within looped portion of the cutting chain exposed above the table through the slot and then the hydraulic cylinder is actuated to draw the cutting chain taut about the pipe until the pipe is cut.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a pipe cutting system that will overcome the shortcomings of the prior art devices.

A second object is to provide a pipe cutting system for quickly and efficiently severing a cast iron pipe.

Another object is to provide a pipe cutting system that does not require significant physical assertion by a user.

An additional object is to provide a pipe cutting system that reduces the likelihood of bodily injury to a user.

A further object is to provide a pipe cutting system that increases productivity for individuals cutting cast iron pipe.

Another object is to provide a pipe cutting system that reduces costs for plumbers.

A further object is to provide a pipe cutting system that is able to cut various diameters and thickness of cast iron pipe.

Another object is to provide a pipe cutting system that does not require adjustment of the length of the cutting chain.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with a cast iron pipe loosely positioned within the cutting chain.

FIG. 3 is an upper perspective view of the present invention with the cutting chain taut about the cast iron pipe.

FIG. 4 is a side view of the present invention.

FIG. 5 is a side view of the present invention with the cutting chain loosely surrounding the cast iron pipe.

FIG. 6 is a side view of the present invention with the cutting chain tightly surrounding the cast iron pipe.

FIG. 7 is a top view of the present invention.

FIG. 8 is a front view of the present invention with a pipe severed by the cutting chain.

### DESCRIPTION OF THE PREFERRED EMBODIMENT

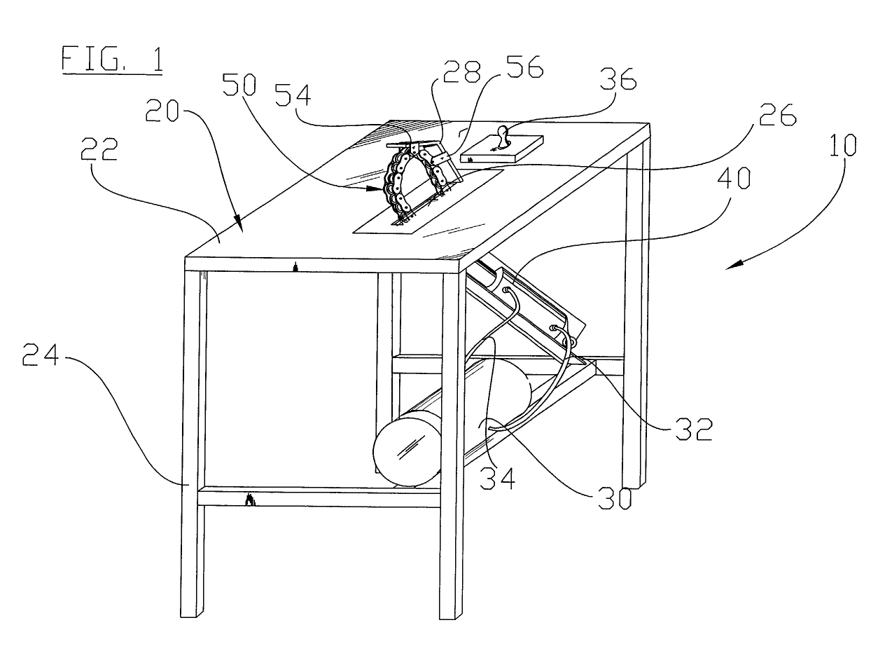

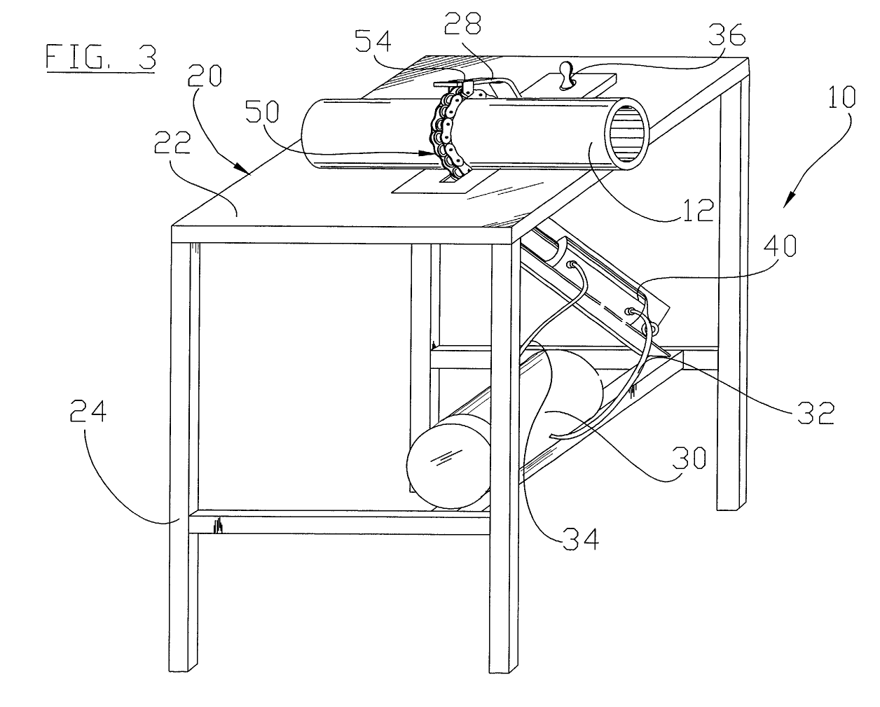

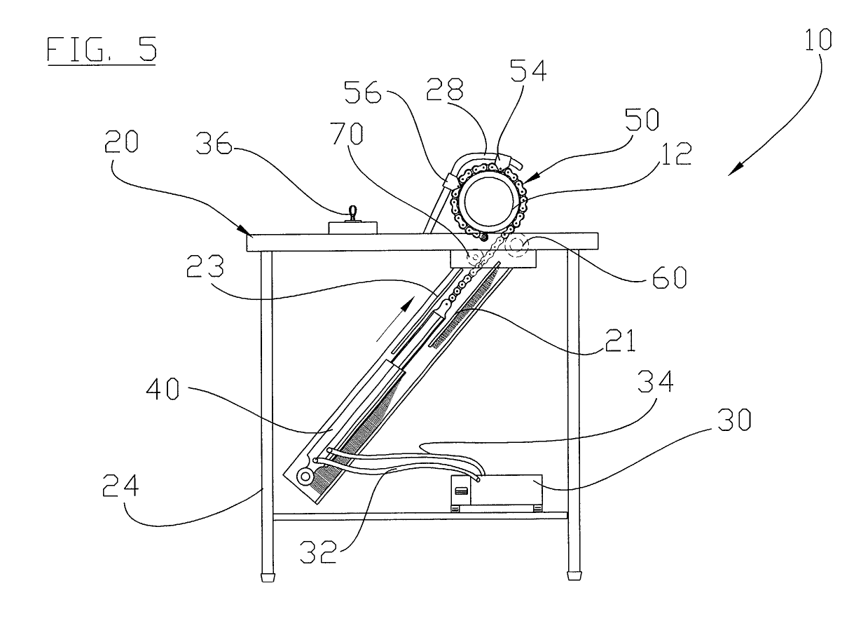

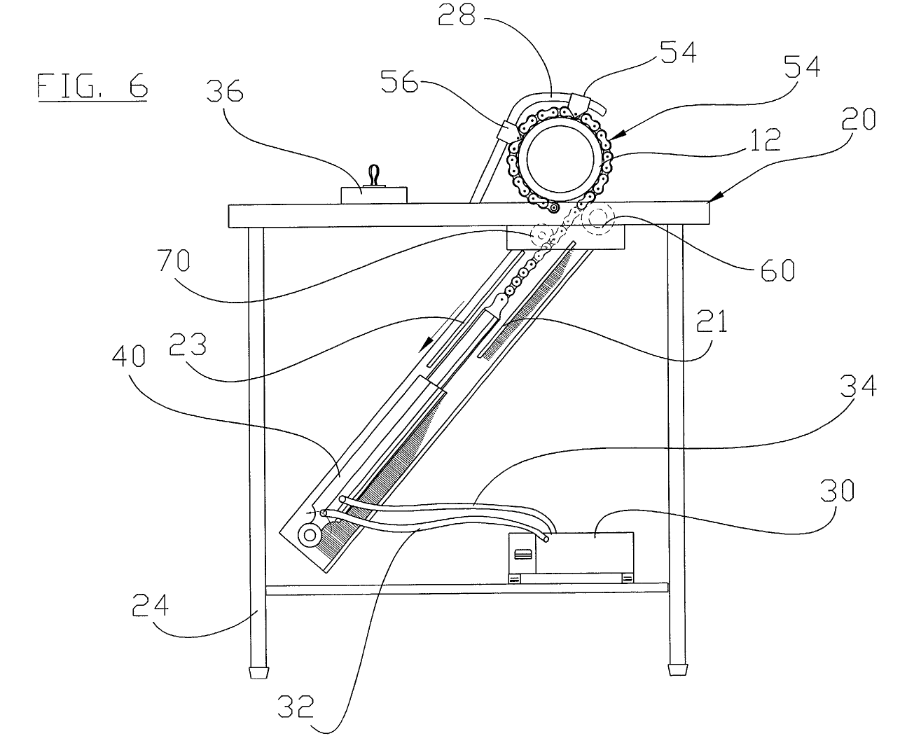

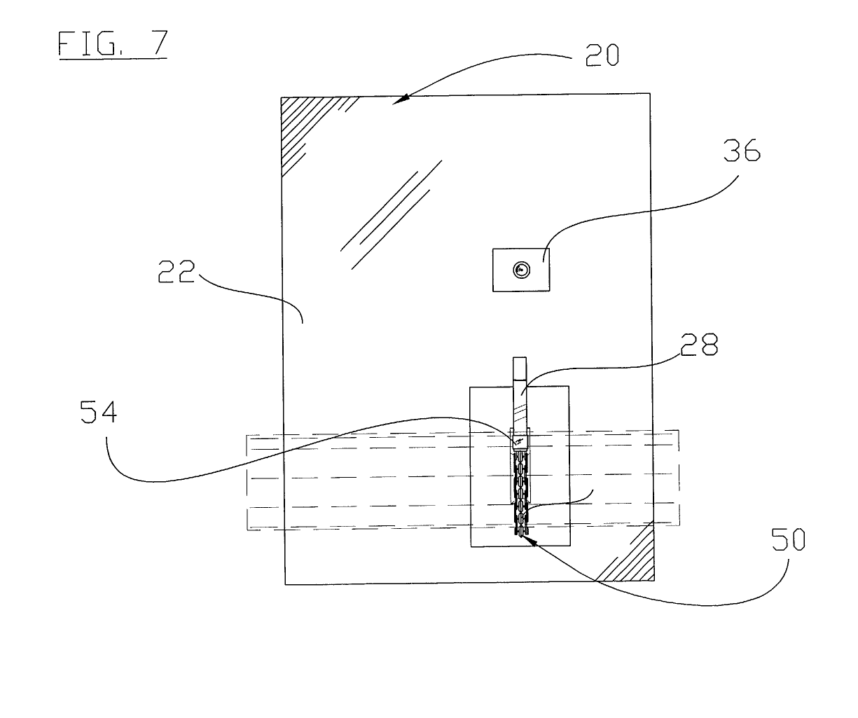

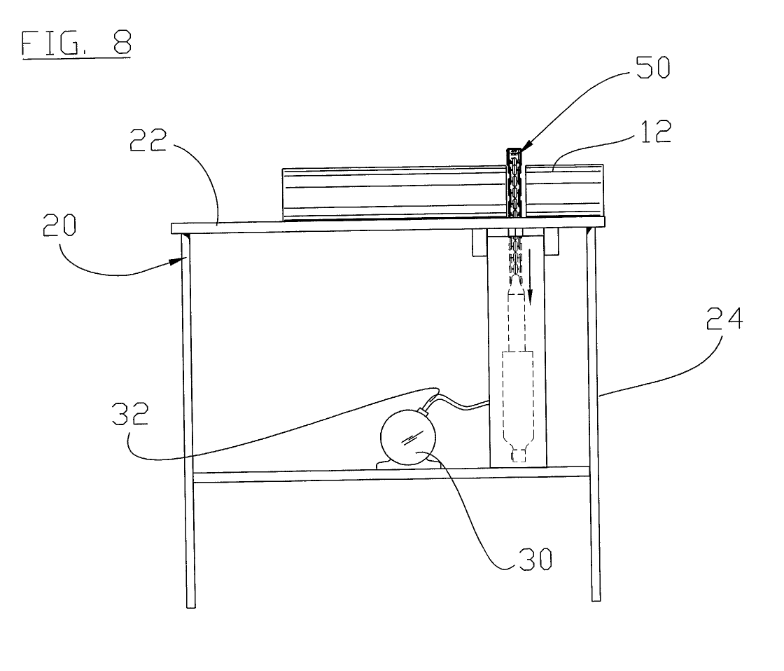

Turning now descriptively to the drawings, in which similar reference characters denote similar elements throughout the several views, FIGS. 1 through 8 illustrate a pipe cutting system 10, which comprises a table 20 having an upper slot 26, a hydraulic pump unit 30, a hydraulic cylinder 40, and a cutting chain 50 attached between the hydraulic cylinder 40 and the table 20 extending upwardly through the slot 26 in a looped manner. A first guide roller 60 and a second guide roller 70 guide the cutting chain 50 during operation. The cast iron pipe 12 is positioned within looped portion of the cutting chain 50 exposed above the table 20 through the slot 26 and then the hydraulic cylinder 40 is actuated to draw the cutting chain 50 taut about the pipe 12 until the pipe 12 is cut.

As shown in FIGS. 1 through 8 of the drawings, the table 20 is comprised of a conventional structure commonly utilized within workbenches and similar structure. The table 20 includes an upper surface 22 supported upon a frame having a plurality of legs 24. It can be appreciated that the table 20 illustrated in the figures is merely illustrative of one embodiment and that various other embodiments may be utilized to construct and utilize the present invention.

As shown in FIGS. 1 through 6 of the drawings, a hydraulic pump unit 30 is attached within the table 20. The hydraulic pump unit 30 may be comprised of any conventional pump system that are commonly utilized to pump fluids. A first hose 32 and a second hose 34 are fluidly connected to the hydraulic pump unit 30 and the distal ends of the hoses 32, 34 are fluidly connected to a hydraulic cylinder 40. A control switch 36 is in communication with the hydraulic pump unit 30 for controlling the operation of the hydraulic pump unit 30 and the hydraulic cylinder 40.

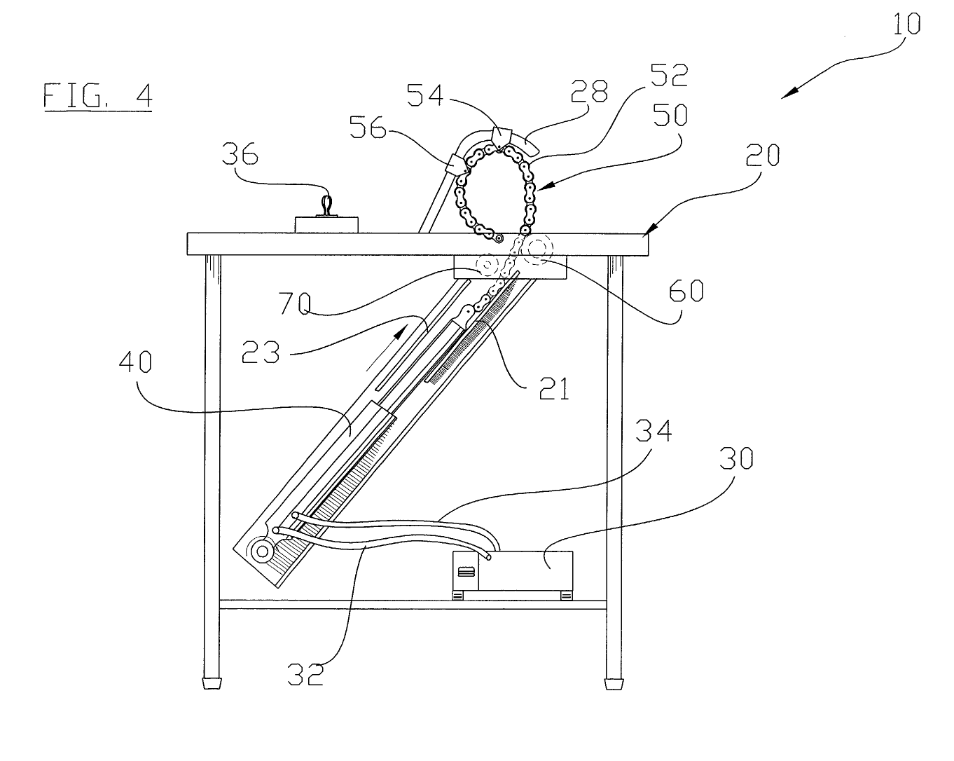

As best shown in FIGS. 4 through 6 of the drawings, the lower end of the hydraulic cylinder 40 is attached to the frame of the table 20. The shaft slidably extending from the hydraulic cylinder 40 is attached to an end of the cutting chain 50 as further illustrated in FIGS. 4 through 6 of the drawings. It can be appreciated that more than one hydraulic cylinder 40 may be utilized with the present invention. It can also be appreciated that the hydraulic cylinder 40 may be comprised of an electrical powered actuator or similar device for drawing and loosening the cutting chain 50 about a pipe 12.

As shown in FIG. 1 of the drawings, a slot 26 extends through the upper surface 22 of the table 20 for receiving a looped portion of the cutting chain 50. The cutting chain 50 is attached within the interior portion of the slot 26 as best illustrated in FIG. 4 of the drawings. The cutting chain 50 is comprised of a length of conventional cutting chain 50 having a plurality of cutting wheels 52 within that are commonly utilized within hand powered cutters. The opposing end of the cutting chain 50 is attached to the distal end of the hydraulic cylinder 40 which draws and loosens the cutting chain 50 about the pipe 12 during operation. The cutting chain 50 is positioned so that a looped portion thereof extends above the upper surface 22 for receiving the diameter of the pipe 12 to be severed.

A support arm 28 is attached to the upper surface 22 of the table 20 as best illustrated in FIGS. 4 through 7 of the drawings. The support arm 28 is preferably an L-shaped structure that extends about and over the slot 26. A first bracket 54 and a second bracket 56 extending from the support arm 28 are attached to the cutting chain 50 in specific locations for supporting the cutting chain 50 in a looped manner above the upper surface 22 of the table 20. The support arm 28 is constructed of a resilient material for allowing conforming of the cutting chain 50 about the pipe 12 during cutting without interfering with the operation.

As shown in FIGS. 4 through 6 of the drawings, a first guide roller 60 is preferably rotatably positioned within the table 20 within the slot 26 for guiding the cutting chain 50 about the lower portion of the pipe 12 when the cutting chain 50 is loose. When the cutting chain 50 is tightened about the pipe 12 the cutting chain 50 preferably does not engage the first guide roller 60.

As shown in FIGS. 4 through 6 of the drawings, a second guide roller 70 is preferably rotatably positioned within the table 20 within the slot 26 for guiding the cutting chain 50 about the lower portion of the pipe 12 when the cutting chain 50 is taut. When the cutting chain 50 is loosened about the pipe 12 the cutting chain 50 preferably does not engage the second guide roller 70. The second guide roller 70 preferably includes a concentric groove within the central portion thereof for receiving the cutting wheels 52 of the cutting chain 50.

As further shown in FIGS. 4 through 6 of the drawings, a lower guide 21 and an upper guide 23 are attached to the frame of the table 20 about the hydraulic cylinder 40 and the cutting chain 50. The guides 21, 23 prevent the cutting chain 50 and the hydraulic cylinder 40 from becoming misaligned when the cutting chain 50 is loose.

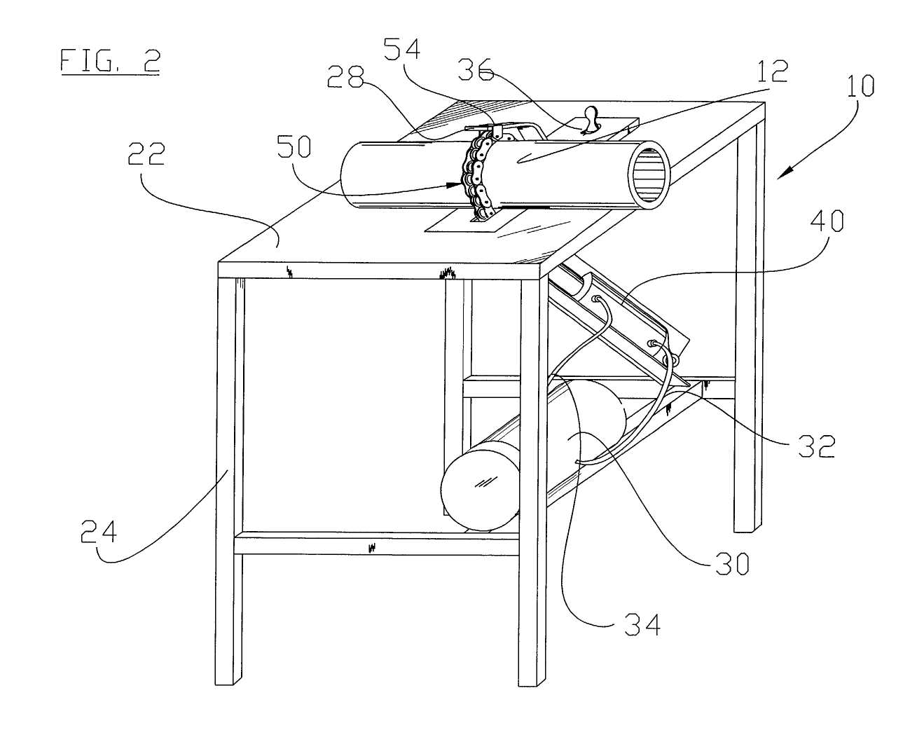

In use, the user positions a length of pipe 12 to be cut within the upper looped portion of the cutting chain 50 extending above the upper surface 22 of the table 20 as best illustrated in FIGS. 2, 3, 5 and 6 of the drawings. The user then aligns the pipe 12 so that the cutting wheels 52 are aligned in the desired cut location of the pipe 12. The user then manipulates the control switch 36 to operate the hydraulic pump unit 30 which applies hydraulic pressure upon the hydraulic cylinder 40 causing the hydraulic cylinder 40 to contract resulting in the tightening of the cutting chain 50 about the pipe 12. As the cutting chain 50 is becoming tightened about the pipe 12, the support arm 28 is drawn downward toward the pipe 12. The hydraulic cylinder 40 continues to draw the cutting chain 50 inwardly through the slot 26 causing the cutting wheels 52 of the cutting chain 50 to eventually cut through or break the pipe 12 in the desired location. The user then manipulates the control switch 36 to cause the hydraulic cylinder 40 to become extended thereby loosening the cutting chain 50 from about the pipe 12. As the cutting chain 50 is loosened, the resilient support arm 28 elevates the cutting chain 50 upwardly thereby allowing the pipe 12 to be completely removed without interference. The user then is able to insert another pipe 12 to be cut thereby repeating the above process.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A pipe cutting system, comprising:
a frame having an upper surface and a slot within said upper surface;
a length of cutting chain having a first end and a second end, wherein said first end is attached to said frame and extending through said slot forming a looped portion exposed above said upper surface returning through said slot, wherein said looped portion is capable of receiving a diameter of a pipe to be severed; and
an actuator means connected to said cutting chain for tightening and loosening said cutting chain about said pipe.

2. The pipe cutting system of claim 1, wherein said actuator means is comprised of a hydraulic pump unit fluidly connected to a hydraulic cylinder, wherein said hydraulic cylinder is connected to said cutting chain.

3. The pipe cutting system of claim 1, wherein said actuator means is comprised of an actuator device.

4. The pipe cutting system of claim 1, including a first guide roller and a second guide roller attached within said frame adjacent said slot for guiding said cutting chain.

5. The pipe cutting system of claim 4, wherein said second guide roller includes a concentric groove for receiving a plurality of cutting wheels of said cutting chain.

6. The pipe cutting system of claim 5, including a lower guide and an upper guide attached within said frame about said cutting chain and a portion of said actuator means.

7. The pipe cutting system of claim 1, including a control switch in communication with said actuator means.

8. The pipe cutting system of claim 1, wherein said first end of said cutting chain is positioned adjacent a center point of said pipe to be cut.

9. The pipe cutting system of claim 8, wherein said cutting chain extends about said pipe from said first end passing near said first end of said cutting chain.

10. The pipe cutting system of claim 1, wherein said cutting chain includes a plurality of cutting wheels.

11. A pipe cutting system, comprising:
a frame having an upper surface and a slot within said upper surface;
a length of cutting chain having a first end and a second end, wherein said first end is attached to said frame and extending through said slot forming a looped portion exposed above said upper surface returning through said slot, wherein said looped portion is capable of receiving a diameter of a pipe to be severed;
a resilient support arm attached to said upper surface above said slot and attached to said cutting chain for supporting said looped portion of said cutting chain for receiving said pipe; and
an actuator means connected to said cutting chain for tightening and loosening said cutting chain about said pipe.

12. The pipe cutting system of claim 11, wherein said actuator means is comprised of a hydraulic pump unit fluidly connected to a hydraulic cylinder, wherein said hydraulic cylinder is connected to said cutting chain.

13. The pipe cutting system of claim 11, wherein said actuator means is comprised of an actuator device.

14. The pipe cutting system of claim 11, including a first guide roller and a second guide roller attached within said frame adjacent said slot for guiding said cutting chain.

15. The pipe cutting system of claim 14, wherein said second guide roller includes a concentric groove for receiving a plurality of cutting wheels of said cutting chain.

16. The pipe cutting system of claim 15, including a lower guide and an upper guide attached within said frame about said cutting chain and a portion of said actuator means.

17. The pipe cutting system of claim 11, including a control switch in communication with said actuator means.

18. The pipe cutting system of claim 11, wherein said first end of said cutting chain is positioned adjacent a center point of said pipe to be cut.

19. The pipe cutting system of claim 18, wherein said cutting chain extends about said pipe from said first end passing near said first end of said cutting chain.

20. The pipe cutting system of claim 11, including a first bracket and a second bracket extending from said support arm and engaging said cutting chain for supporting said looped portion in a substantially circular shape above said upper surface of said frame.
